(19) United States
(12) Patent Application Publication
(10) Pub. No.: US 2012/0170117 A1
(43) Pub. Date: Jul. 5, 2012

(54) POLARIZER PLATE, OPTICAL APPARATUS, AND METHOD OF MANUFACTURING POLARIZER PLATE

(76) Inventors: Hyeon CHO, Uiwang-si (KR); Eun Mi Kim, Uiwang-si (KR); Jong Gyu La, Uiwang-si (KR); Tae Hwan Noh, Uiwang-si (KR); Jin Sook Kim, Uiwang-si (KR); Hae Ryong Chung, Uiwang-si (KR); Moon Yeon Lee, Uiwang-si (KR); Ji Heon Kim, Uiwang-si (KR)

(21) Appl. No.: 13/337,627

(22) Filed: Dec. 27, 2011

(30) Foreign Application Priority Data
Dec. 29, 2010 (KR) 10-2010-0138222

(51) Int. Cl. G02B 5/30; B29D 11/00; B29D 7/01

(52) U.S. Cl. 359/487.01; 264/1.34; 264/1.35

(57) ABSTRACT

A polarizer plate includes a polarizer that includes polyvinyl alcohol and a dichroic material, the polarizer having a degree of orientation of 15 or more as represented by Equation 1: Degree of orientation=R_{D}/R_{PVA}×100, where R_{PVA} represents a phase difference of the polyvinyl alcohol and R_{D} represents a phase difference of the dichroic material.

### BACKGROUND

1. Field

Embodiments relate to a polarizer plate, an optical apparatus, and a method of manufacturing a polarizer plate.

2. Description of the Related Art

A liquid crystal display (LCD) is a flat panel display which is widely used.

Generally, a liquid crystal display includes a liquid crystal layer encapsulated between a thin film transistor (TFT) array substrate and a color filter substrate. The liquid crystal display displays an image based on variation of arrangement of liquid crystal molecules in the liquid crystal layer upon application of an electric field to electrodes disposed on the array substrate and the color filter substrate.

Generally, the liquid crystal display includes polarizer plates outside the array substrate and the color filter substrate. Each of the polarizer plates allows selective transmittance of light traveling in a certain direction among light entering from a backlight unit and light passing through the liquid crystal layer, thereby achieving polarization. A polarizer plate may include a polarizer capable of polarizing light in a specific direction, and a protective layer for supporting and protecting the polarizer.

### SUMMARY

An embodiments is directed to a polarizer plate, including a polarizer that includes polyvinyl alcohol and a dichroic material, the polarizer having a degree of orientation of 15 or more as represented by Equation 1: Degree of orientation=R_{D}/R_{PVA}×100, where R_{PVA} represents a phase difference of the polyvinyl alcohol and R_{D} represents a phase difference of the dichroic material.

The degree of orientation may be in the range of 15 to 30.

The dichroic material may be iodine.

The phase difference of polyvinyl alcohol (R_{PVA}) may be in the range of 500 to 800.

The phase difference of the dichroic material (R_{D}) may be in the range of 90 to 130.

The polarizer plate may have a color change (Δa) of 0.4 or less as measured after being left at 70° C. for 48 hours.

The polarizer plate may have a color change (Δb) of 1.5 or less as measured after being left at 70° C. for 48 hours.

Another embodiment is directed to an optical apparatus including a polarizer plate according to an embodiment.

Another embodiment is directed to a method of manufacturing a polarizer plate, the method including swelling a polyvinyl alcohol film having a degree of crystallinity of 0.40 or more, dyeing the swollen polyvinyl alcohol film, and stretching the dyed polyvinyl alcohol film.

The degree of crystallinity may be in the range of 0.40 to 0.43.

The dyed polyvinyl alcohol film may be stretched to a ratio of 5.5 to 6.5 times.

The method may further include color-correcting the stretched polyvinyl alcohol film.

The color-correcting of the stretched polyvinyl alcohol film may be performed in a color-correcting bath containing 1 to 6 wt % of potassium iodide.

### BRIEF DESCRIPTION OF THE DRAWINGS

Features will become apparent to those of skill in the art by describing in detail exemplary embodiments with reference to the attached drawings in which:

FIG. 1 illustrates a side view of a polarizer plate in accordance with an example embodiment; and

FIG. 2 to FIG. 6 illustrate graphs depicting orthogonal transmittance of polarizer plates including polarizers of Examples 1 to 3 and Comparative Examples 1 and 2.

### DETAILED DESCRIPTION

Korean Patent Application No. 10-2010-0138222, filed on Dec. 29, 2010, in the Korean Intellectual Property Office, and entitled: “Polarizer Plate, Optical Apparatus, and Method of Manufacturing Polarizer Plate,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

An example embodiment relates to a polarizer plate.

The polarizer plate according to an embodiment may include a polarizer having a degree of orientation of 15 or more, where the degree of orientation is represented by Equation 1:

Degree of orientation=R_{D}/R_{PVA}×100,

where R_{PVA} represents a phase difference of polyvinyl alcohol and R_{D} represents a phase difference of dichroic material, described below in detail.

The degree of orientation is the phase difference ratio of the dichroic material to polyvinyl alcohol. The degree of orientation may be used as an index that indicates the degree of parallel alignment of the dichroic material with respect to the polyvinyl alcohol molecules. The degree of orientation may be measured using a phase difference tester. The phase difference of the polyvinyl alcohol (R_{PVA}) may be obtained by subtracting the phase difference of the dichroic material (R_{D}) from the phase difference of the polarizer or the polarizer plate.

Maintaining the degree of orientation at 15 or more helps avoid negative transmittance, poor polarizing efficiency, and poor durability of the polarizer plate. With this degree of orientation, the polarizer may have advantageous properties in terms of transmittance, polarizing efficiency and durability. Preferably, the degree of orientation is in the range of 15 to 30.

The degree of orientation may be a value with respect to a polarizer or may be a value with respect to a polarizer plate (which has a protective film attached to at least one side of the polarizer).

The polarizer may be manufactured by adsorbing a dichroic material to a polyvinyl alcohol film and stretching the polyvinyl alcohol film. The phase difference of polyvinyl alcohol (R_{PVA}) is 500 to 800, and the phase difference of the dichroic material (R_{D}) may be 90 to 130, preferably 110 to 130.

The polarizer plate according to the present example embodiment may have a color change in CIE Lab a value (Δa) of 0.4 or less and a color change in CIE Lab b value (Δb) of 1.5 or less after being left at 70° C. for 48 hours in an oven.

In an embodiment, the color change (Δa) may be 0.1 to 0.4, and the color change (Δb) may be 1.0 to 1.5. Small color changes (Δa, Δb) of a polarizer plate mean that the polarizer plate has excellent durability. By stretching a polyvinyl alcohol film having a high degree of crystallinity to increase the degree of orientation, it may be possible to achieve high durability.

The polarizer may have a thickness of 0.5 to 400 μm, preferably 5 to 200 μm, and more preferably 5 to 50 μm.

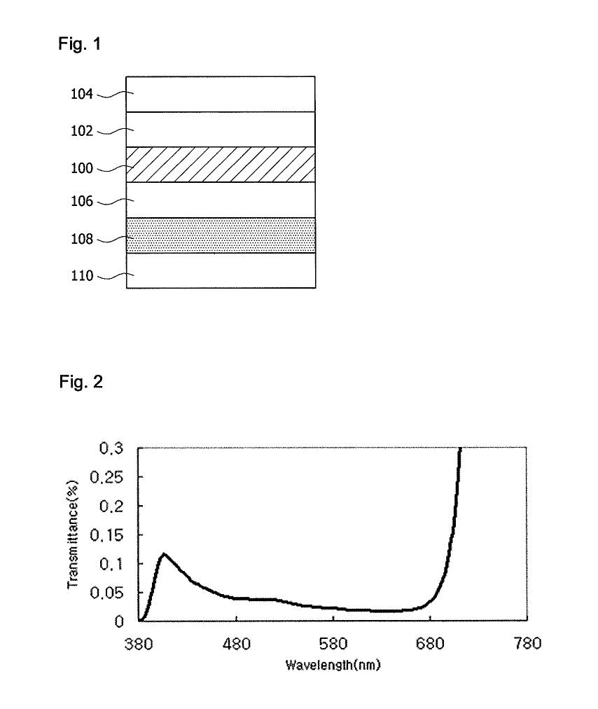

FIG. 1 illustrates a side view of a polarizer plate in accordance with an example embodiment.

Referring to FIG. 1, the polarizer plate according to the present example embodiment includes a polarizer 100, a first protective film 102 stacked on an upper surface of the polarizer 100, and a second protective film 106 stacked on a lower surface of the polarizer 100. A third protective film 104 may be stacked on an upper surface of the first protective film 102, and a release film 110 may be stacked on a lower surface of the second protective film 106 via an adhesive layer 108.

The first and second protective films 102, 106 may be, e.g., acetate films (such as tri-acetyl-cellulose (TAC) films), polycarbonate films, polyamide films, polyimide films, polyolefin films, polyester films, polyether sulfone films, etc. In an implementation, TAC films may be used as the first and second protective films 102, 106. The adhesive layer 108 may be a pressure sensitive adhesive (PSA) layer. In the present example embodiment, the adhesive layer 108 includes a pressure sensitive layer.

The above embodiment is illustrated as one example. For example, the polarizer plate may further include an antiglare (AG) layer, an antireflective coating (ARC) layer, and the like between the first protective film 102 and the protective film 104, and a compensation layer (compensation film) between the second protective film 106 and the adhesive layer 108. The polarizer plate may further include a brightness enhancing film, a reflective film, an anti-transmittance reflective film, a diffusing film, and the like. In another implementation, some of the protective films may be omitted.

The polarizer plate may be a polarizer plate for TN (Twisted Nematic) liquid crystals, STN (Super Twisted Nematic) liquid crystals, horizontal arrangement mode liquid crystals, such as IPS (In-Plane Switching), Super-IPS or FFS (Fringe Field Switching), or vertical arrangement mode liquid crystals. Thus, the polarizer plate according to the present invention may be applied to any of various liquid crystal modes.

Another example embodiment relates to an optical apparatus.

For example, the optical apparatus may be a liquid crystal display including the polarizer plate described above. The liquid crystal display may include an edge type backlight unit or direct type backlight unit, and a liquid crystal panel mounted on one side of the backlight unit.

In the present example embodiment, the liquid crystal panel includes a liquid crystal layer between an upper substrate and a lower substrate, on which polarizer plates according to an embodiment are stacked as an upper polarizer plate and a lower polarizer plate, respectively. The liquid crystal layer may include TN (Twisted Nematic) liquid crystals, STN (Super Twisted Nematic) liquid crystals, horizontal arrangement mode liquid crystals, such as IPS (In-Plane Switching), Super-IPS, or FFS (Fringe Field Switching), or vertical arrangement mode liquid crystals. The liquid crystal panel may be a passive matrix or an active matrix. In an implementation, the liquid crystal panel may be a thin film transistor (TFT) active matrix liquid crystal panel. The liquid crystal display may be used for image display in electronic devices such as mobile phones, monitors, TVs, tablet PCs, notebook computers, and the like.

A further example embodiment relates to a method of manufacturing a polarizer plate.

In an example embodiment, the method of manufacturing a polarizer plate includes a polarizer manufacturing process including swelling, dyeing, stretching, and the like, and a protective film attachment process.

Polarizer Manufacturing Process

A polarizer according to the present example embodiment may be manufactured by swelling, dyeing, and stretching a polyvinyl alcohol (PVA) film.

The polyvinyl alcohol film may be selected from among any commercially available polyvinyl alcohol films. Alternatively, the polyvinyl alcohol film may be produced by solvent casting, melt extrusion, or the like. In solvent casting, a resin solution prepared by dissolving a resin in a solvent is coated on a casting roll or belt, followed by evaporation of the solvent, thereby producing a desired film. In melt extrusion, a resin is melted at a melting point or more, followed by extrusion and cooling through cooling rolls, thereby producing a desired film. A solution for preparing the polyvinyl alcohol film may further include a plasticizer for enhancing flexibility of the polyvinyl alcohol film and a surfactant for facilitating separation of the dried polyvinyl alcohol film from a belt or drum.

The polyvinyl alcohol film may have a degree of crystallinity of 0.40 or more, described below in detail. With a degree of crystallinity of 0.40 or more, the polarizer produced may have advantageous properties in terms of transmittance, high polarizing efficiency, and durability. In an implementation, the polyvinyl alcohol film may have a degree of crystallinity of 0.40 to 0.43.

The degree of crystallinity may be obtained by Equation 2:

Degree of crystallinity=B/A×100,

wherein A represents intensity of a reference band at 1425 cm⁻¹ as determined via FT-IR (Fourier transform infrared spectroscopy) measurement, and B represents intensity of a polyvinyl alcohol film at 1140 cm⁻¹ as determined via FT-IR measurement.

The reference band may be a baseline output upon FT-IR measurement.

The polarizer may manufactured by stretching the prepared polyvinyl alcohol film or a suitable commercially-available polyvinyl alcohol film. The following processes for manufacturing the polarizer are provided for illustration only, and thus the method may further include other processes not described herein or may eliminate some processes described herein. Further, it should be understood that the following numerals do not indicate the sequence of the processes, which can be changed in other implementations.

A) Swelling

Rinsing and/or swelling of the polyvinyl alcohol film may be performed before dyeing the polyvinyl alcohol film. Rising is performed to remove foreign matter from the polyvinyl alcohol film. Swelling is performed to provide an efficient dyeing process. In an implementation, the polyvinyl alcohol film is passed through a swelling bath, which may accommodate water or chloride, boric acid, an inorganic acid, an organic solvent, or the like, and may be maintained at 20 to 30° C. Preparation and selection of the swelling bath may be carried out by a general process therefor.

B) Dyeing

The swollen polyvinyl alcohol film is subjected to dyeing with a dichroic material to impart polarization properties to the film. The dichroic material is a material that exhibits a significant difference in the degree of light absorption between a major axis and a minor axis thereof, and any suitable material that selectively absorbs one component of polarized light components orthogonal to each other may be used as the dichroic material to provide polarization properties. For example, iodine, dichroic pigments, and the like may be used.

When dyeing the polyvinyl alcohol film with iodine molecules, an iodine dyeing bath may include potassium iodide or boric acid in addition to iodine. The dyeing may be performed at a temperature of 20˜40° C.

After dyeing, the polyvinyl alcohol film may be further subjected to crosslinking. In an implementation, in order to allow the iodine molecules to be more strongly attached to the polyvinyl alcohol matrix, boric acid may be used as a crosslinking agent and phosphoric acid may be further added thereto.

C) Stretching

The dyed polyvinyl alcohol film may be further subjected to stretching. A dry stretching method or a wet stretching method may be utilized for this process. Examples of the dry stretching may include an inter-roll stretching method, a compression stretching method, a heated roll stretching method, and the like.

A bath for wet stretching may contain boric acid and may be maintained at a temperature in the range of 35 to 65° C. In an implementation, the bath may contain 0.1 to 10 wt % of boric acid. The boric acid may serve as a cross-linker between molecular chains of the polyvinyl alcohol, thereby suppressing I₃⁻ or I₅⁻ from being decomposed into I₂ and I⁻ during drying.

Stretching may be performed simultaneously with dyeing or crosslinking. When stretching is performed simultaneously with dyeing, these processes may be performed in an iodine solution, and when stretching is performed simultaneously with crosslinking, these processes may be performed in a boric acid solution. Stretching may also be performed simultaneously with color correction as described below.

The stretching process forms a polarization axis, and may be performed to provide a stretched ratio of, e.g., 2 to 7 times, preferably 5 to 7 times, more preferably 5.5 to 6.5 times.

The method may further include color correction after swelling, dyeing, and stretching.

D) Color correction

The stretched polyvinyl alcohol film may be further subjected to color correction for color calibration of the polyvinyl alcohol film. Color correction may be performed in a color correction bath that contains, e.g., potassium iodide (KI) and/or boric acid. In an implementation, color correction may be performed in a color correction bath that contains 1 to 10 wt % of potassium iodide, and preferably 1 to 6 wt % of potassium iodide. The color correction bath may further contain 0.1 to 3 wt % of boric acid. The potassium iodide may be used to increase the total amount of I₅⁻ to absorb light in the red spectrum (expansion of the spectrum), thereby enhancing durability.

Protective Film Attachment

When the manufactured polarizer is moved while being wound upon a winder, a process of attaching a protective film to at least one side of the polarizer may be performed. Although various films may be used as the protective film, a tri-acetylcellulose (TAC) film is advantageously used. In the present example embodiment, a TAC film is used as the protective film. The TAC film for the polarizer plate should provide transparency, flatness, and optical isotropy, and serves to protect the polarizer that polarizes light and includes polyvinyl alcohol. Two TAC films may be attached to upper and lower surfaces of the polarizer.

Attachment of the TAC film to the stretched polyvinyl alcohol film may be achieved by, e.g., attaching the TAC film to the polyvinyl alcohol film while winding the TAC film from an unwinding roller onto a winding roller.

In addition to the protective film, functional films such as a compensation film and the like may be attached to the stretched polyvinyl alcohol film.

Drying Process

The manufactured polarizer and the protective film attached to one or more sides of the polarizer may be subjected to drying. In another implementation, the manufactured polarizer may be subjected to drying before attachment of the protective film thereto. Drying may be performed at, e.g., a temperature of 40 to 85° C. for 1 to 15 minutes. Drying may be performed by, e.g., radiant heat drying such as hot air drying, near-infrared heating, or the like.

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect. A description of details apparent to those skilled in the art may be omitted.

### Example 1

A polyvinyl alcohol film (Kuraray Co., Ltd.) having an average degree of polymerization of 2400 and a degree of crystallinity of 0.425 was dipped into and washed in ion exchange water. The polyvinyl alcohol film was then immersed for 10 seconds in water containing iodine/potassium iodide in a ratio of 1/23 (in terms of weight ratio) and having a temperature of 30° C. Then, the polyvinyl alcohol film was stretched to 6.2 times in water containing 3 wt % of boric acid and having a temperature of 50° C. The polyvinyl alcohol film was subjected to color correction in water containing 4.0 wt % of potassium iodide, and dried in an oven at 50° C. for two minutes, thereby providing a polarizer.

### Example 2

The polarizer according to Example 2 was manufactured by the same method as in Example 1 except that a polyvinyl alcohol film having a degree of crystallinity of 0.422 was stretched to 6 times and color correction was performed using water containing 3.5 wt % of potassium iodide in a color correction bath.

### Example 3

The polarizer according to Example 3 was manufactured by the same method as in Example 1 except that a polyvinyl alcohol film having a degree of crystallinity of 0.418 was stretched to 5.8 times and color correction was performed using water containing 3.0 wt % of potassium iodide in a color correction bath.

### Comparative Example 1

A polyvinyl alcohol film (Kuraray Co., Ltd.) having an average degree of polymerization of 2400 and a degree of crystallinity of 0.394 was dipped into and washed in ion exchange water. The polyvinyl alcohol film was then immersed for 10 seconds in water containing iodine/potassium iodide in a ratio of 1/23 (in terms of weight ratio) and having a temperature of 30° C. Then, the polyvinyl alcohol film was stretched to 5.8 times in water containing 3 wt % of boric acid and at a temperature of 50° C. The polyvinyl alcohol film was subjected to color correction in water containing 3.0 wt % of potassium iodide, and dried in an oven at 50° C. for two minutes, thereby providing a polarizer.

### Comparative Example 2

The polarizer according to Comparative Example 2 was manufactured by the same method as in Comparative Example 1 except that a polyvinyl alcohol film having a degree of crystallinity of 0.390 was subjected to color correction using water containing 3.5 wt % of potassium iodide in a color correction bath, followed by drying at 55° C.

Testing

In Examples 1 to 3 and Comparative Examples 1 to 2, optical and physical properties of the polyvinyl alcohol films, the manufactured polarizers, and polarizer plates including the manufactured polarizer were evaluated by the following methods.

(1) Degree of crystallinity: A FT-IR (Fourier transform infrared spectroscopy) tester Model No. FTS-7000 (Varian Co., Ltd.) was used to measure the degree of crystallinity. The FT-IR spectrometer was equipped with an ATR (Attenuated Total Reflectance) module to measure the degree of crystallinity. Specifically, the polyvinyl alcohol film was cut in half without pretreatment, and a cut section of the film was brought into contact with a diamond cell of the ATR. Then, the ATR was locked and a screw on the ATR was turned to allow the diamond cell to be brought into close contact with the surface of the sample. Specifically, the screw at an upper side of the ATR was turned about 20 times to provide a constant degree of contact between the diamond cell and the cut section of the sample, followed by measurement of the spectrum. Then, with the screw of the ATR slightly released, the ATR was unlocked to clean the diamond cell, and the ATR was locked again to measure the background. In FT-IR measurement, intensity (A) of a reference band at 1425 cm⁻¹ and intensity (B) of the polyvinyl alcohol film at 1140 cm⁻¹ were obtained, and the degree of crystallinity was calculated according to the Equation B/A×100.

(2) Degree of orientation: A phase difference tester KOBRA-WX100/IR (OSI Co., Ltd.) was used to measure the degree of orientation. The degree of orientation was measured with respect to a polarizer plate including TAC protective films attached to opposite sides of a polarizer. Specifically, with a sample, i.e. polarizer plate, evenly secured at a position corresponding to a light source, a measurement manner was selected by continuous measurements according to the sample size. The measurement is accomplished in wavelengths 300 nm˜1200 nm, for example 845.1 nm, 903.3 nm, 952.1 nm, 1000.0 nm, 1046.5 nm and 1092.7 nm. Rc and Rs are results output according to the KOBRA-WX100/IR. Rc is derived from Cauchy equation

$$n = A + \frac{B}{{λ}^{2}} + \frac{C}{{λ}^{4}} + \frac{D}{{λ}^{6}}$$

and output in the type of curvature according to KOBRA-WX100/IR. A to D of the Cauchy equation are determined in the wavelength, thus n=Rc is output. Rs is derived from Sellmeier equation

$$n = A + \frac{B}{{λ}^{2} - {λ}_{0}^{2}} .$$

A and B of the Sellmeier equation are determined in the wavelength. By the continuous measurements in the wavelength, Rs is adjusted to be consistent with Rc. Rs i.e. Rc equals to R_{D}+R_{PVA} which is total phase difference of the polarizer at the specific wavelength for example 1000.0 nm. Then, with the sample disposed between polarizers parallel to each other, a polarized light beam of a single wavelength was irradiated upon an upper end of the sample to pass through the sample to obtain the phase difference and the orientation angle of the sample from angle dependency of the light beam passing through the sample. The phase differences of the polarizer plate (R_{D}+R_{PVA}), the dichroic material (R_{D}) and the polyvinyl alcohol (R_{PVA}) were output. The phase difference of polyvinyl alcohol (R_{PVA}) may be also obtained by subtracting the phase difference of the dichroic material (R_{D}) from the phase difference of the total polarizer plate (R_{D}+R_{PVA}). The degree of orientation was obtained using Equation 1 described above. It was assumed that the protective films TAC did not have any influence upon the degree of orientation. There was no difference between the case in which the degree of orientation was measured only with respect to the polarizer and the case in which the degree of orientation was measured with respect to the polarizer plate. When the degree of orientation was measured using the polarizer plate, a measurement error could be reduced due to the even surface of the polarizer plate.

(3) Transmittance, polarizing efficiency, and color value: A UV-VIS spectrophotometer Model No V-7100 (Jasco Co., Ltd.) was used to measure transmittance, polarizing efficiency, and color value. Measurement was performed with respect to a polarizer plate including TAC protective films attached to opposite sides of a polarizer. Light having wavelengths of 380 to 780 nm was passed through a Glan-Thompson prism and converted into polarized light. Then, the transmittance, polarizing efficiency, and color value of the polarizer plate were measured when the polarized light was parallel or orthogonal to an absorption axis of the polarizer plate while passing through a 1.5φ polarizer plate. Single transmittance, parallel transmittance, cross-Nicol transmittance, and polarizing efficiency of the polarizer plate were obtained according to equations stored in the spectrophotometer, and the color values were output as an a-value, b-value, and x-value and y-value in CIE Lab value with respect to a D65 light source.

(4) Durability: Heat resistance testing was performed to measure durability. Specifically, when there is a change in the a-value or the b-value due to application of heat, the color of the polarizer plate varies and a desired color thus is not expressed on a display device, and such a phenomenon relates to durability. Durability was measured with respect to a polarizer plate including TAC protective films attached to opposite sides of a polarizer. After being left at 70° C. for 48 hours, changes in the color values (Δa, Δb) were analyzed using a spectrometer model V-7100.

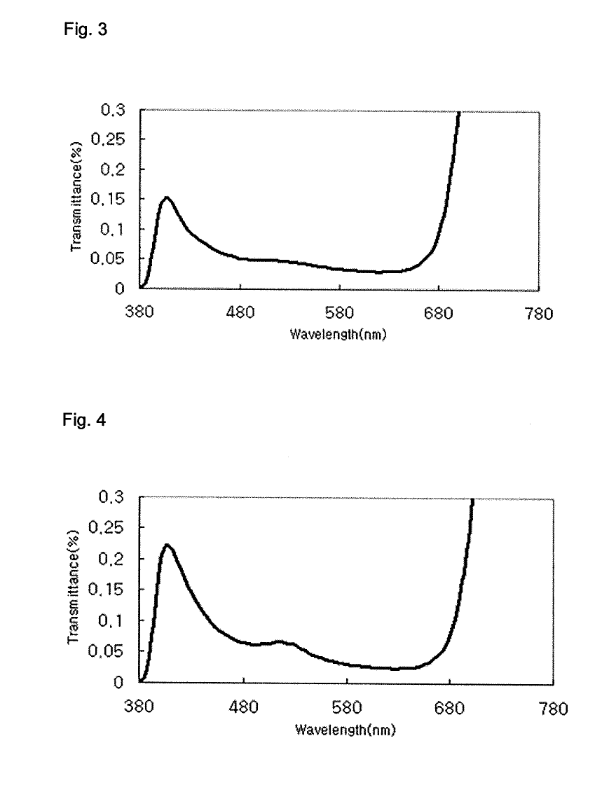

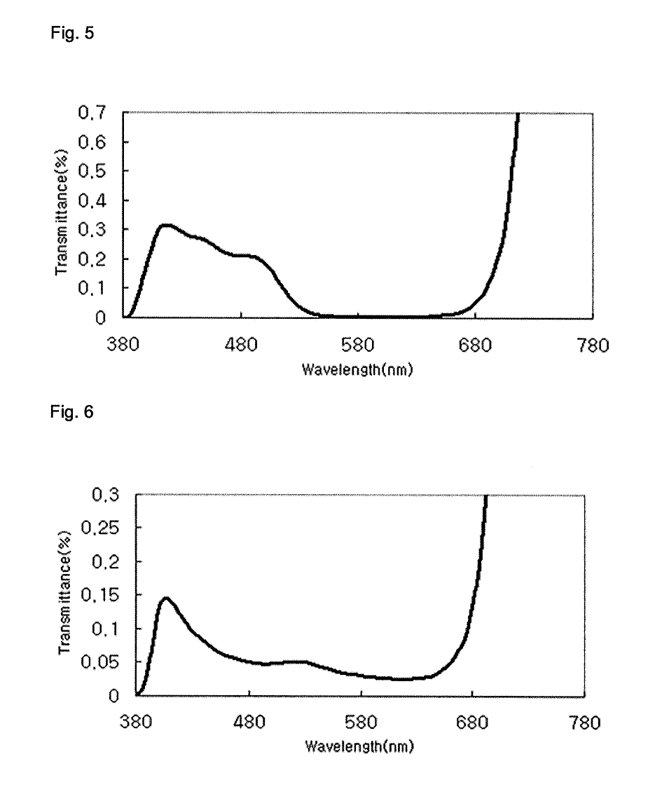

FIG. 2 to FIG. 6 illustrate graphs depicting orthogonal transmittance of polarizer plates including polarizers of Examples 1 to 3 and Comparative Examples 1 and 2. Below, Table 1 shows the degree of crystallinity of the polyvinyl alcohol films used for the Examples and the Comparative Examples, and the degree of orientation of the polarizer plates manufactured thereby, Table 2 compares optical characteristics of the polarizer plates including the polarizers manufactured by the Examples and the Comparative Examples, Table 3 shows the color values of the polarizer plates including the polarizers manufactured by the Examples and the Comparative Examples, and Table 4 shows variation in color of the polarizer plates including the polarizers manufactured by the Examples and the Comparative Examples.

TABLE 1

| | FT-IR degree of | | | Degree of |
|---|---|---|---|---|
| | crystallinity | | | orientation |
| Sample No. | (ATR) | R_{PVA} | R_{D} | (RD/RPVA × 100) |
| Example 1 | 0.425 | 696.5 | 126.3 | 18.1 |
| Example 2 | 0.422 | 756.7 | 123.3 | 16.3 |
| Example 3 | 0.418 | 775.0 | 119.1 | 15.4 |
| Comparative | 0.394 | 812.3 | 114.5 | 14.1 |
| Example 1 | | | | |
| Comparative | 0.390 | 850.9 | 118.3 | 13.9 |
| Example 2 | | | | |

TABLE 2

| | | Polarizing |
|---|---|---|
| | Transmittance | efficiency |
| Sample No. | (%) | (%) |
| Example 1 | 43.15 | 99.94 |
| Example 2 | 43.11 | 99.90 |
| Example 3 | 43.07 | 99.89 |
| Comparative | 43.01 | 99.89 |
| Example 1 | | |
| Comparative | 42.46 | 99.92 |
| Example 2 | | |

TABLE 3

| Sample No. | Color (a) | Color (b) |
|---|---|---|
| Example 1 | −1.31 | 3.20 |
| Example 2 | −1.18 | 3.17 |
| Example 3 | −1.22 | 2.95 |
| Comparative | −1.32 | 3.42 |
| Example 1 | | |
| Comparative | −1.23 | 3.25 |
| Example 2 | | |

TABLE 4

| Sample No. | Color change (Δa) | Color change (Δb) |
|---|---|---|
| Example 1 | 0.17 | 1.13 |
| Example 2 | 0.33 | 1.40 |
| Example 3 | 0.33 | 1.20 |
| Comparative | 0.54 | 1.80 |
| Example 1 | | |
| Comparative | 0.49 | 2.13 |
| Example 2 | | |

In Table 1, it can be seen that the degree of orientation of the polarizer plate obtained by Equation 1 increases with increasing degree of crystallinity of the non-stretched polyvinyl alcohol film. Thus, the polarizer plates according to Examples 1 to 3 having high degrees of crystallinity of the non-stretched polyvinyl alcohol film and high degrees of orientation of the stretched polyvinyl alcohol film had superior single transmittance and polarizing efficiency relative to those of Comparative Examples 1 and 2. In other words, Comparative Example 1 had a much lower polarizing efficiency than Examples 1 to 3, and Comparative Example 2 had a much lower transmittance than Examples 1 to 3.

Also, when analyzing variation of the color values after leaving the polarizer plate at 70° C. for 48 hours in an oven, an average variation of the color values (Δa) of the polarizer plates according to Examples 1 to 3 was 0.28, whereas an average variation of the color values (Δa) of the polarizer plates according to Comparative Examples 1 and 2 was 0.515. Further, an average variation of the color values (Δb) of the polarizer plates according to Examples 1 to 3 was 0.515, whereas an average variation of the color values (Δb) of the polarizer plates according to Comparative Examples 1 and 2 was 1.965. Thus, it can be seen that the polarizer plates according to Examples 1 to 3 exhibited little variation in the color values and thus had substantially improved durability when left at high temperature for a long period of time.

By way of summation and review, a polarizer may be generally prepared by dyeing a polyvinyl alcohol film with dichroic iodine, followed by cross-linking the film with boric acid or borax and stretching. High degrees of transmittance and polarization are advantageous for the polarizer plate. However, as the degree of transmittance increases, the polarizer plate may exhibit decreased polarizing efficiency, thereby reducing contrast. Thus, obtaining a high degree of transmittance without deteriorating polarizing efficiency is desired. Moreover, as the range of applications of liquid crystal displays has expanded, use of liquid crystal displays under high temperature conditions also increases, and thus there is a need for a polarizer plate having durability and undergoing less color change under such conditions.

As described above, embodiments relate to a polarizer plate, an optical apparatus, and a method of manufacturing a polarizer plate. Embodiments may provide a polarizer plate having high transmittance, high polarization, and high durability, an optical apparatus including the polarizer plate, and a method of manufacturing the polarizer plate.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A polarizer plate, comprising:
a polarizer that includes polyvinyl alcohol and a dichroic material, the polarizer having a degree of orientation of 15 or more as represented by Equation 1:
Degree of orientation=R_{D}/R_{PVA}×100,
where R_{PVA} represents a phase difference of the polyvinyl alcohol and R_{D} represents a phase difference of the dichroic material.

2. The polarizer plate as claimed in claim 1, wherein the degree of orientation is in the range of 15 to 30.

3. The polarizer plate as claimed in claim 1, wherein the dichroic material is iodine.

4. The polarizer plate as claimed in claim 1, wherein the phase difference of polyvinyl alcohol (R_{PVA}) is in the range of 500 to 800.

5. The polarizer plate as claimed in claim 1, wherein the phase difference of the dichroic material (R_{D}) is in the range of 90 to 130.

6. The polarizer plate as claimed in claim 1, wherein the polarizer plate has a color change (Δa) of 0.4 or less as measured after being left at 70° C. for 48 hours.

7. The polarizer plate as claimed in claim 1, wherein the polarizer plate has a color change (Δb) of 1.5 or less as measured after being left at 70° C. for 48 hours.

8. An optical apparatus including a polarizer plate as claimed in claim 1.

9. A method of manufacturing a polarizer plate, the method comprising:
swelling a polyvinyl alcohol film having a degree of crystallinity of 0.40 or more;
dyeing the swollen polyvinyl alcohol film; and
stretching the dyed polyvinyl alcohol film.

10. The method as claimed in claim 9, wherein the degree of crystallinity is in the range of 0.40 to 0.43.

11. The method as claimed in claim 9, wherein the dyed polyvinyl alcohol film is stretched to a ratio of 5.5 to 6.5 times.

12. The method as claimed in claim 9, further comprising color-correcting the stretched polyvinyl alcohol film.

13. The method as claimed in claim 12, wherein the color-correcting of the stretched polyvinyl alcohol film is performed in a color-correcting bath containing 1 to 6 wt % of potassium iodide.
